(19) United States
(12) Patent Application Publication
(10) Pub. No.: US 2012/0189193 A1
(43) Pub. Date: Jul. 26, 2012

(54) DETECTION OF OBJECTS REPRESENTED IN IMAGES

(75) Inventors: Gary Overett, Kambah (AU); Lars Petersson, Braddon (AU); Lars Andersson, Ainslie (AU); Niklas Pettersson, Florey (AU)

(73) Assignee: NATIONAL ICT AUSTRALIA LIMITED, Eveleigh, NSW (AU)

(21) Appl. No.: 13/376,071

(22) PCT Filed: Jun. 3, 2009
(86) PCT No.: PCT/AU2009/000699

§ 371 Date: Mar. 27, 2012

(51) Int. Cl. G06K 9/62

(52) U.S. Cl. 382/159; 382/195; 382/224

(57) ABSTRACT

The invention relates to computer vision, in particular detection and classification of objects captured in a video stream of images. The invention provides a memory efficient method of storing images that have been pre-processed for use in object detection. The method is based on using histograms of orientation. The invention also includes methods for training and using weak classifiers that use this pre-processing of images. A first weak classifier uses the total count of two orientation values in a histogram as an index to a two dimensional confidence table to determine a confidence value. The second weak classifier projects one or more total counts of orientation values in a histogram into a scalar value that is then used in a one dimensional confidence map to determine a confidence value. Aspects of the invention include methods, computer systems and software.

### TECHNICAL FIELD

The invention relates to computer vision, in particular but not limited to, detection and classification of objects captured in a video stream of images. Embodiments of the invention relate to pre-processing of images for use in object detection, training and using weak classifiers on the pre-processed images. Aspects of the invention include methods, computer systems and software.

### BACKGROUND ART

Today there are many successful pattern recognition approaches in the domain of computer vision for detecting objects represented in images. Many of these approaches give good detection performance, and with varying support for properties such as scale invariance, rotational invariance and perspective invariance.

Detection and classification of objects represented in a stream of images (i.e. video) is increasingly becoming a crucial functionality in many real-world systems. Some applications of object detection need to be able to support real-time computation. For example, application of object detection to images captured by an on-board camera in a vehicle to detect road signs, pedestrians and other vehicles must be able to operate in real-time.

### SUMMARY OF THE INVENTION

In a first aspect the invention provides a method of pre-processing an image for use in detecting objects represented in the image, the method comprising the steps of:
(a) determining an orientation value of each point in the image;
(b) for a subset of points in the image determining a distribution of orientation values of points within the subset;
(c) repeating step (b) for different subsets of points; and
(c) storing each of the distributions of orientation values in memory, each distribution stored as one word in memory.

A word defines the width of a computer's bus meaning that the a word can be read from memory in a single operation. It is an advantage of this invention that a full distribution can be read, from memory by one single access, this is particularly important for implementations of the invention on inexpensive embedded systems where there is little or no memory cache available or there is limited bandwidth to memory. Further, this pre-processing offers greater flexibility as it can be used by different types of classifiers.

The word may be comprised of 16, 32, or 64 bits. The orientation value of each point may be one of eight values. The subset may be comprised of 16 points.

In a distribution of orientation values, a total count of an orientation value may be stored as 4 bits in memory. The method may further comprise determining whether a total count for an orientation value in a distribution of orientation values is more than 15, and if so performing overflow prevention.

Step (a) may further comprise determining an approximate magnitude for each point. The magnitude of a point is the absolute sum of vertical and horizontal gradients for that point. Step (b) may further comprise only adding the orientation value of a point of a subset to the distribution of that subset if the magnitude is greater than a threshold. It is an advantage of at least one embodiment of the invention that thresholding points in this was may increase the object detection that is performed on the pre-processed image.

Each distribution may have a root point and the distributions of each subset may be stored in sequence according to the sequence that the root points are in the image.

Further aspects of the first aspect include memory, software and a computer system. The computer system of this aspect (and the aspects below may be an FPGA).

In a second aspect the invention provides a method of training a weak classifier to be used in detecting an object represented in an image, the method comprising the steps of:
(a) for each image of a image training set, determining or receiving a pre-processed version of the image comprised of multiple distributions of orientation values, where each count of an orientation value in a distribution of orientation values is associated with a point from a subset of points in the image;
(b) using the pre-processed versions of the images, determining a confidence map that can provide a confidence level that a subset of points associated with a distribution of orientation values is at least part of a representation of the object in the image, the index to the confidence map being a total count of two or more orientation values of a distribution of orientation values; and
(c) forming a weak classifier that includes the confidence map.

Step (a) may comprises determining the pre-processed version of the image according to the first aspect of the invention.

Further aspects of the second aspect of the invention includes software, memory and a computer system.

In a third aspect the invention provides a method of detecting an object represented in an image using a classifier comprised of multiple weak classifiers, the method comprising the steps of:
(a) determining or receiving a pre-processed version of the image comprised of multiple distributions of orientation values where each count of an orientation value in a distribution of orientation values is associated with a point from a subset of points in the image;
(b) for each weak classifier,
   (i) based on the weak classifier, identifying a total count of two or more orientation values in one of the distributions of orientation values;
   (ii) based on the weak classifier and the identified total count of two or more orientation values, determining a confidence level; and
(c) combining each confidence level to determine a combined confidence level for the image as having the object represented in the image.

Step (a) may comprise determining the pre-processed version of the image according to the method of the first aspect of the invention.

Each weak classifier may identify the counts of which two or more orientation values are to be identified in step (b)(i).

Each weak classifier may have an associated confidence map having the total counts of two or more orientation values as the axes, and step (b)(ii) may comprise determining the confidence value in the confidence map that corresponds to the identified total counts of the two or more orientation values in the one distribution of orientation values.

The weak classifier may be trained according to the method of the second aspect of the invention.

Further aspects of the third aspect of the invention includes software and a computer system.

In a fourth aspect the invention provides a method of training a weak classifier to be used in detecting an object represented in an image, the method comprising the steps of:
(a) for each image of a first and a second image set, wherein images of the first image set include a representation of the object and images of the second image set do not include a representation of the object, determining or receiving a pre-processed version of the image comprised of multiple distributions of orientation values where each count of an orientation value in a distribution of orientation values is associated with a point from a subset of points in the image;
(b) determining a projection that discriminates between the pre-processed versions of the first image set and the pre-processed versions of the second image set; and
(c) forming a weak classifier that includes this projection.

The method may further comprise determining a confidence map that uses as an index the result of the projection to provide a confidence value.

Step (b) may utilise Fisher's Discriminant Analysis.

Further aspects of the fourth aspect of the invention includes software, memory and a computer system.

In a fifth aspect the invention provides a method of detecting an object represented in an image using a classifier comprised of multiple weak classifiers, the method comprising the steps of:
(a) determining or receiving a pre-processed version of the image comprised of multiple distributions of orientation values where each count of an orientation value in a distribution is associated with a point from a subset of points in the image;
(b) for each weak classifier
   (i) projecting total counts or one or more orientation values of a distribution of orientation values to a scalar value using a projection of the weak classifier, and
   (ii) determining a confidence level based on the scalar value and the weak classifier; and
(c) combining each confidence level to determine a combined confidence level for the image as having the object represented in the image.

The weak classifier of step (b) may be trained according to the method of the fourth aspect of the invention.

Step (b)(ii) may comprise using a one-dimensional confidence map of the weak classifier that has as an index the scalar value.

In step (b)(i), the one or more orientation values may be determined by the weak classifier.

Further aspects of the fifth aspect of the invention is software and a computer system.

The detection of the object in the image may automatically infer classification of the identified object as the weak classifier may be trained to only detect a particular class of object.

### BRIEF DESCRIPTION OF THE DRAWINGS

An example of the invention will now be described with reference to the following drawings:

FIG. 1 shows an overview of the flow of steps of pre-processing used in this example.

FIG. 2 shows unconventional encoding of the different orientation used in pre-processing of this example;

FIG. 3 schematically represents a histogram image;

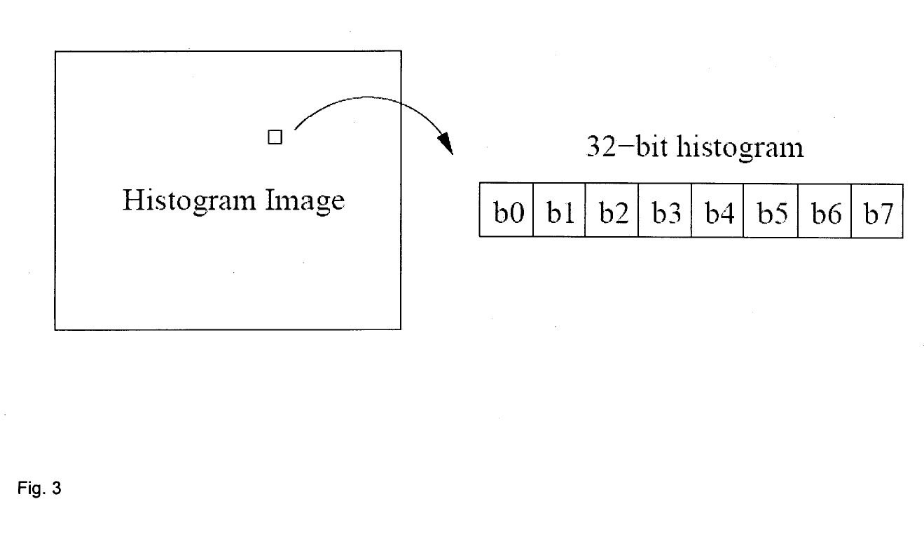

FIG. 4 schematically shows a a posteriori map where the two orientation bins selected from a histogram are used to index the map according to the first embodiment of a weak classifier of this example;

FIG. 5 are some sample a posteriori maps of FIG. 4;

FIG. 6 shows an overview of the flow of steps for training a second embodiment of a weak classifier of this example; and

FIG. 7 shows an overview of the flow of steps for evaluation of a second embodiment of a weak classifier.

### BEST MODE OF THE INVENTION

The computer vision system of this example is on board a vehicle and therefore has limited computational resources. This example includes an efficient family of weak classifier, that can be used in ensemble classifiers constructed by using a boosting techniques such as Adaboost [1], to create strong classifiers.

### Computer System

In this example the computer vision system includes a digital video camera that is able to capture sequential images of the scene. Naturally, the images represent objects that in the scene such as pedestrians, vehicles and road signs. In this example we will concentrate of the detection of road signs.

The images are stored in memory from where they are provided as input to a processor, which in this example is a Field Programmable Gate Array (FPGA).

The result of pre-processing (described below) of the images is also stored in memory which are again provided to the processor as input for evaluation by classifiers (also described in detail below).

The result of the detection and classification processing is then provided as output to another computer system, which can also be on board the vehicle or external. For example, if a ‘stop’ road sign is detected, a notification such as a audio notification can be raised in real-time.

Alternatively, the invention could be performed by a standard micro processor implementation, digital signal processor (DSP), embedded system or a combination of any one or more of these hardware implementations.

### Pre-Processing the Image

In this example the pre-processing is performed on an image to produce a compact representation of the image known here as a “histogram image”. Weak classifiers are then applied to this pre-processed version of the image (described further below). It is an advantage of this example that complex pre-processing is performed on the entire image that can be repeatedly used by each classifier. Further, the pre-processing method can be pipelined, or even implemented in a separate processor to help increase the speed. This pre-processing can also speed up the evaluation of each weak classifier.

It is a further advantage of this invention that the calculations all work on integer, rather than floating point representations of numbers. Using the least possible number of bits to represent each number makes this example suitable for FPGA or DSP implementations.

The bottleneck limiting the speed of most visual detection algorithms is not the speed of the processor but rather the bandwidth to the memory. Since image processing is memory intensive by nature, data does not normally fit in the fast cache memories. Excessive memory accesses leads to poor cache performance which causes the processor to be idle until the lengthy memory access request to main memory returns.

It is a further advantage of this example that it reduces the number of nonlinear memory accesses during feature computation since a majority of the time spent in evaluating a single feature is spent fetching data from memory. In this example more of the feature computation is moved from the evaluation step to the pre-processing step. That means that every memory access can return more useful value and the number of accesses can be reduced. In turn, this limits the memory bandwidth needed. More memory friendly streamlined processing, such as MMX and SSE optimizations in standard CPUs, can then be used at the pre-processing step.

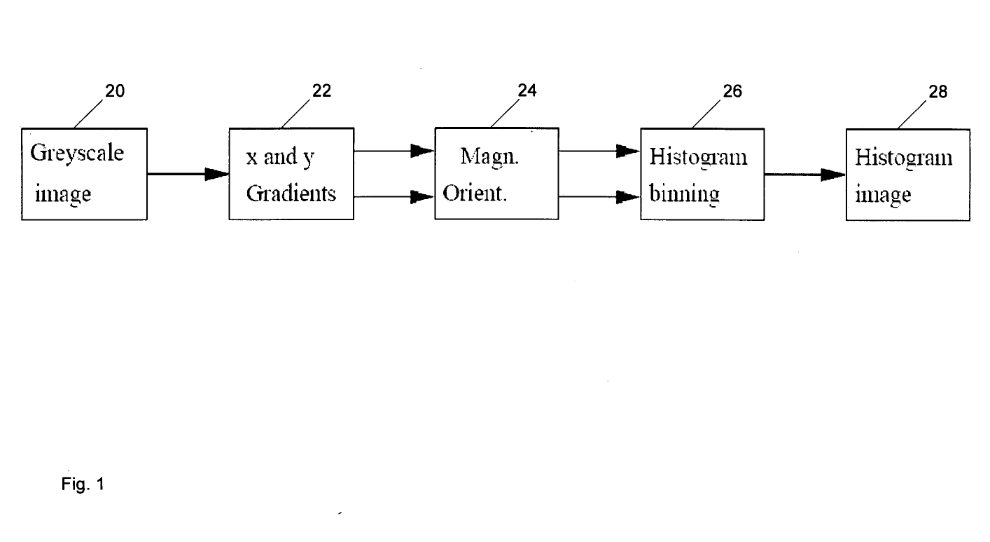

An overview of the computations needed to produce the histogram image is shown in FIG. 1. This is repeated for each or subset of images that comprise the video.

Initially, the image is converted to grey scale image 22. Next, x and y gradients at each point in the image is determined 24. In this example a point is simply a pixel. In other examples, a point may be a group of pixels or the points may be pixels but the method is not performed for each pixel.

The x and y gradients of a greyscale image can be calculated in a number of ways. The simplest is finite differences with the [−1, 0, 1] kernel.

We then use these x and y gradients to determine 26 the orientations and magnitudes at each pixel. A pixel's orientation is represented by a number between zero and seven. Hence, it can be stored as a 3 bit value.

Reducing the number of different orientations to such a low number as eight means that we can simply determine the orientation via a sequence of comparisons. More specifically,

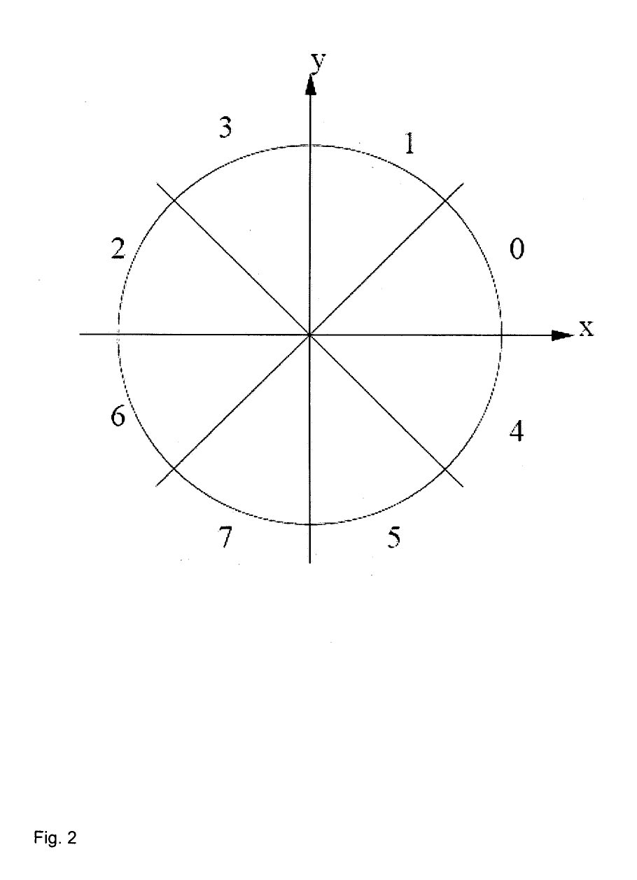

ori_{x,y}=(G_{y}<0)·4+(Gₓ<0)·2+(|Gy|>|Gx|)·1 (1)

Where ori_{x, y} is the orientation at pixel (x, y), Gₓ is the x gradient at pixel (x, y) and G_{y} si the y gradient at pixel (x, y). In other words we divide orientation space into 8 bins. Each pixel in the greyscale image is assigned one of these eight orientations, depending on which sector of orientation space its orientation falls in. This results in the unconventional encoding of the different orientations shown in FIG. 2. This encoding is designed to avoid the evaluation of slower trigonometric identities in calculating orientations. This reduction in complexity of the histogram still provides good discrimination performance and the weak classifiers have a built-in invariance to small rotations.

While calculating the orientation associated with each pixel, we simultaneously calculate the pixel's approximate magnitude 24 by taking the absolute sum of the two gradients Gₓ and G_{y}. This is again a trade-off between the more mathematically correct Euclidean length of the vector and the less accurate but more computationally efficient sum of absolute values.

Next, histogram binning is performed 26 to produce distributions of orientation values that combined comprise the histogram image 28. That is, once the orientations and magnitudes of each pixel have been calculated, we compute a histogram for each possible 4×4 image patch (i.e. subset) in the greyscale image by counting up the orientation values in that small image patch. Thus the maximum value of any histogram bin (i.e. orientation value) is just 16. By checking for this overflow and reducing the occasional value of 16 to 15 we can always capture the count for a histogram bin in just 4 bits. This reduces the total memory requirement for a singe histogram image pixel to just 4×8 bits=32 bits. The overall storage needed for the histogram image is image_width*image-height*4 bytes.

Further, a check is performed so that only those orientations whose corresponding magnitude is greater than some chosen threshold is included in the distribution.

Since this is a power of two the summation of the orientations in the patch can be computed very efficiently. It should also be noted that we create one histogram for each pixel in the original image, thus we have a significant overlap. This is however not a problem since we let the booting algorithm decide which histograms that are to be used by the final strong classifier.

Each 4×4 patch has a root pixel, such as the top left hand pixel. The distributions are stored to memory linearly, where the linear order is based on the order that the root pixels appear in the images.

### First Embodiment of a Weak Classifier

Each weak classifier of this first embodiment contains information about
(i) the relative x and y position of the histogram in the image patch evaluated,
(ii) which bins to use for evaluation, and
(iii) the a posteriori map.

These elements makes up the data structure of one instance of this first embodiment of a weak classifier.

### (i) Relative x and y Position

The relative x and y position refers to the root location of the orientation histogram relative to the root location of the inspected patch.

### (ii) Bin Selection

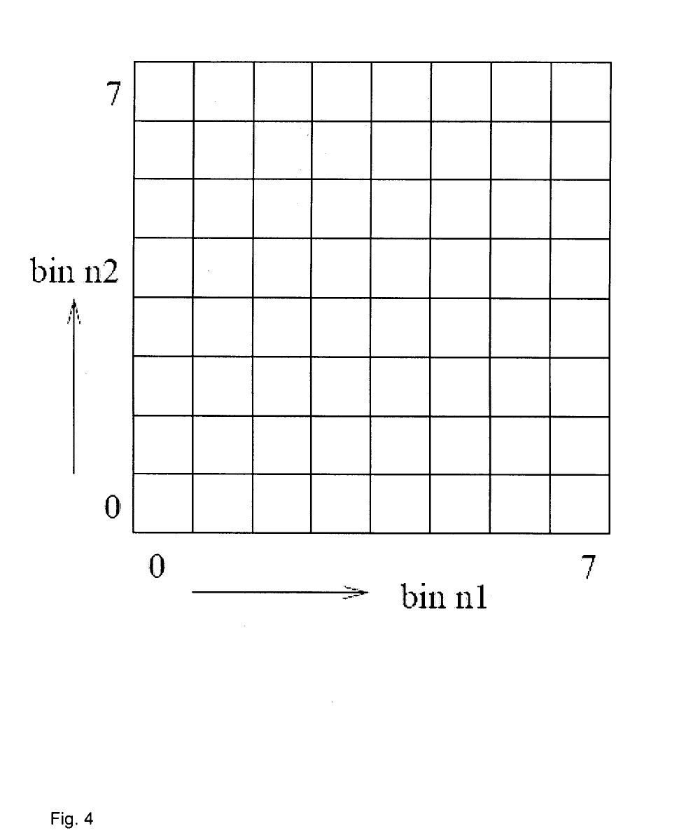

This weak classifier identifies two bins n1 and n2 (see FIG. 4). The identified bins stored in the data structure (described above) of the weak classifier are randomly selected during training.

Since the boosting algorithm discards useless instances of weak classifiers and only chooses the good ones the remaining features can be considered “good” features. As such it is likely that the identified bins n1 and n2 are quite significant, but there is no guarantee it is the most significant pair of bins for identification and classification.

The count of orientations in the histogram for these two bins are used as coordinates in a look up table, also referred here as a posteriori map. This is schematically shown in FIG. 4.

(iii) The a Posteriori Map

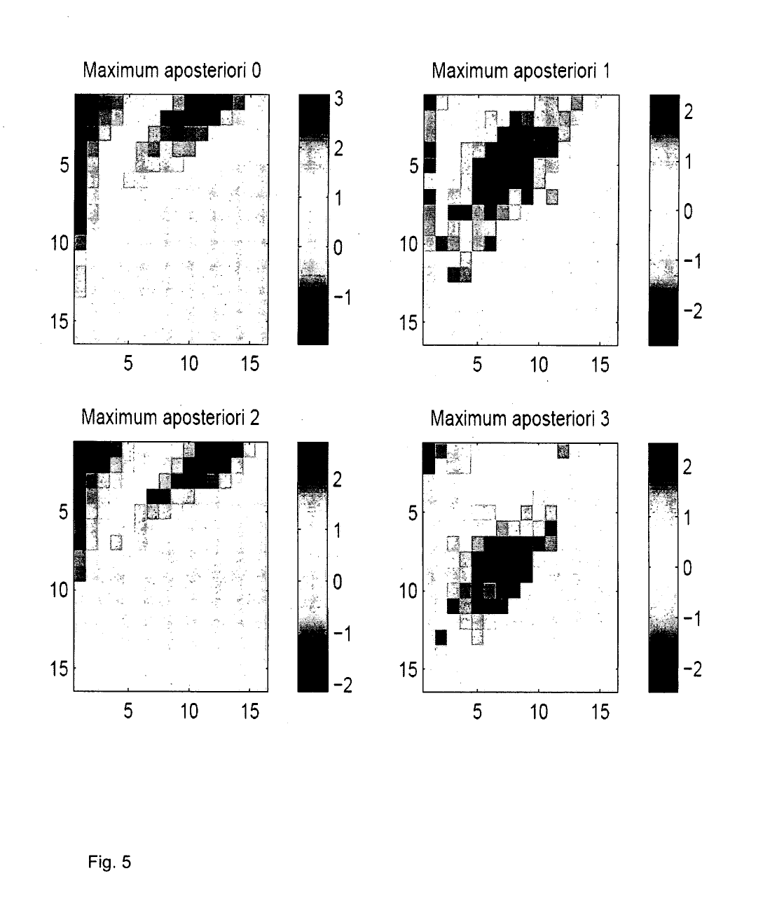

FIG. 5 are examples of a posteriori map for four different weak classifiers where the confidence ratings range from around −3 to −3. The axis of each map represents the counts of orientations in the two selected bins. The shading represents the probability for that particular response being a positive (high confidence) or negative (low confidence) example.

The a posteriori map is created during training from positive and negative training examples. By evaluating each weak classifier and storing its response for each example one can create an a posteriori probability for the histogram image patch being positive when the feature gives a certain response. This is described in detail in [6].

The evaluation of a weak classifier of this second embodiment is really a mapping from R⁸ of the histogram, to R². The R² look up in the a posteriori map provides a R′ value representation of how certain this particular weak classifier is that this histogram represents a positive or negative example of the object to be identified.

The resulting confidence is then used in the summation, as in the boosted classifier approach, to form the strong classifier (described further below). Hence there is virtually no arithmetic processing needed in the evaluation of each weak classifier.

The relative x and y position together with the two bins make up the parameter space for the feature. These are varied randomly to make up a pool of features made available to the boosting algorithm for selection. During training First, two weighted probability distribution functions (PDF), one for the positive and one for the negative training data set is formed.

These functions give the probability of a positive or negative sample given the values in two particular orientation bins (in the case of the second embodiment below given a certain projected scalar value).

A weighting scheme is also used depending on the boosting scheme used which effects how are particular training samples are handled.

Then, these two PDFs are combined to form the confidence lookup table. There are numerous ways of going from a set of positive and negative PDFs to a confidence map. Typically, the boosting algorithm used prescribes which one to use.

A large pool of features is created which explores preferably large portion of the parameter space. The parameters are random and include the relative x and y position, as well as the orientation bins used for indexing the confidence map. The boosting algorithms evaluates every feature in the pool and discards useless ones, or rather it only keeps one single feature. Before selecting feature number two, three and so on, the feature pool is renewed with a new random selection in the parameter space. This helps exploring a large portion of the feature parameter space, especially when the number of features in a stage becomes large.

Strong classifiers can be trained in a variety of ways. Most often, training is done in a cascaded fashion with a number of stages one after the other, each stage rejecting a proportion of the input data. This is a good procedure when trying to achieve the best possible classifier for a particular application.

For each object type to be detected and classified, a machine learning frame work such as AdaBoost can be used to build single strong classifiers consisting of 1 to a very large number of weak classifiers, such as 1000.

### Second Embodiment of a Weak Classifier

This second embodiment is an image based object detection feature which produces a scalar response from an arbitrary subset of the elements of a compact representation (CR) of image statistics. In this example the compact representation is the histogram image described above. Put another way, this weak classifier is a one dimensional linear projection of all eight orientations that is used to index a 1 dimensional hypothesis (i.e. 1 dimensional confidence map).

These elements make up the data structure of one instance of the second embodiment of a weak classifier.

### (i) Relative x and y Position

The relative x and y position refers to the root location of the orientation histogram relative to the root location of the inspected patch.

### (ii) Projection Transformation

The projection transformation is applied to the histogram image pixels in such a way as to reduce the dimensionality while maximizing the separation of the positive and negative data points.

In this embodiment, the projection transformation is a Fishers Linear Discriminant (FDA) which reduces the dimensionality to 1D.

(iii) The a Posteriori Map

The a posteriori map in the second embodiment is similar to the one in the first embodiment described above, except that it can be of any dimension. The creation follows the same methodology.

When the projection transformation is FDA, the a posteriori map is formulated to be one dimensional.

The evaluation of a weak classifier of this second embodiment is really a mapping from R⁸ of the histogram, to R. The Rⁿ look up in the a posteriori map provides a R¹ value representation of how certain this particular weak classifier is that this histogram represents a positive or negative example of the object to be identified. In case of FDA, we select n=1.

The relative x and y position together with the projection transformation make up the parameter space for the feature. x and y are varied randomly to make up a pool of features made available to the boosting algorithm for selection. An exhaustive set of suitable projection transformations are computed for each x and y pair.

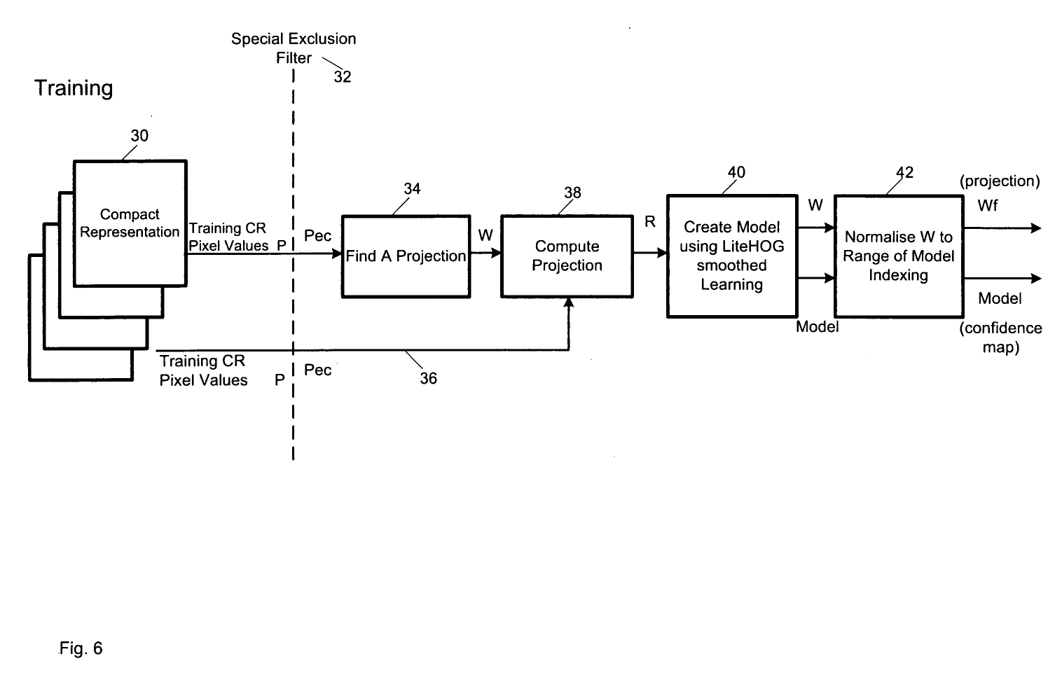

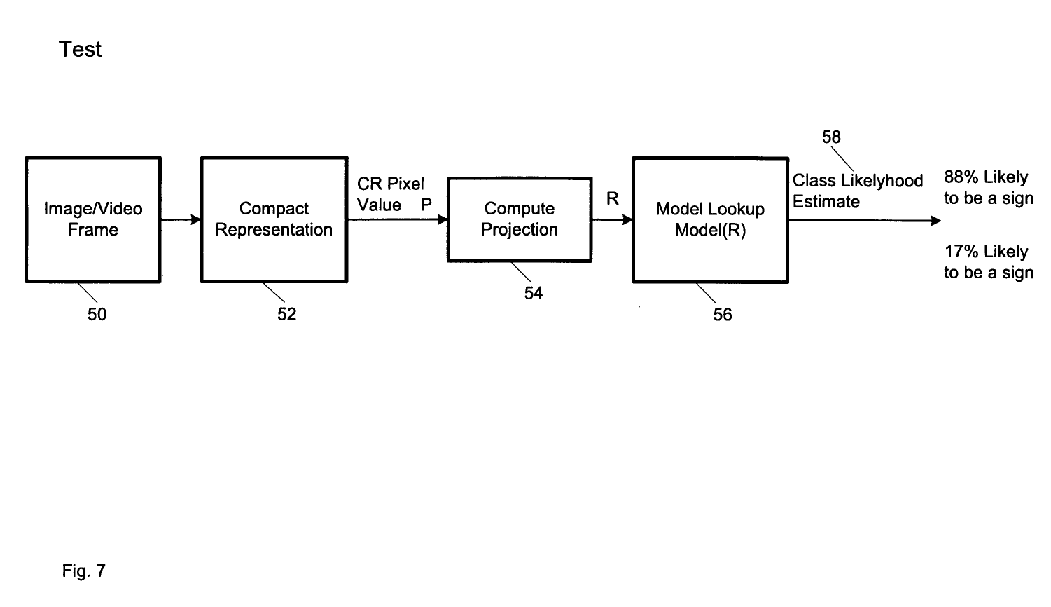

The training of this weak classifier is schematically shown in FIG. 6 and the evaluation of this weak classifier is shown in FIG. 7.

During training (see FIG. 6), compact representations (CR) 30 are formed for each positive and negative training data. The CR pixels are fed through a special exclusion filter 32 to shape the statistical distribution in such a way so that it becomes suitable for mathematical analysis. In this embodiment the filter excludes points at the origin to make the spread of the data more Gaussian.

After the exclusion filter, for each feature in the pool, a set of suitable projections are found (W) 34. The feature pool now consists of features with varying x and y as well as varying projections.

Each feature in the amended feature pool is trained by, again 36, taking the training CR pixels 30, apply the transformations found in the previous step to compute feature responses (R), and collect statistics. (PDFs) for the positive and negative training set in a similar way as in the first embodiment. When, as in the second embodiment, FDA is used and the mapping is towards R1, the feature model is created by using a “smoothed learning” algorithm.

The smoothing algorithm ensures that enough training samples have contributed when estimating the R1 values in the confidence map 40.

The feature training process is concluded by a normalisation 42 of the projection space to allow easy indexing in the created model (confidence map). A normalised projection transformation is computed.

These trained features are then used in, for example, the training of a cascade of boosted classifiers, in the same way as in the first embodiment.

The procedure for Testing is depicted in FIG. 7. For every input image/video frame 50, a Compact Representation 52 as explained above is computed (i.e. distribution of orientation values). For every CR pixel participating in the strong classifier, the projection transformation is applied 54. The output of this projection is used to index the confidence map 56 to retrieve a confidence value 58. This value can, as shown in the picture, inform the strong classifier of the likelihood of the presence of, for example, a road sign. When the strong classifier stage consists of a large number of weak classifiers, the combined result very accurate and reliable, with very low false positive rates and high detection rates.

Further details are now described below.

We create a larger feature space by finding 256 possible projections using FDA on arbitrary subsets of the 8 dimensional histogram image pixel.

Apart from finding better projections, the weak classifier gives a significant reduction in the computation required to evaluate some features. Consider the example where the most discriminant feature is found using a projection of just 3 dimensions. In this case only 3 multiplications, rather than 8, are required in Equation 5. Thus this feature is both faster and more discriminant.

Linear projections are found according to the canonical variate of Fishers Linear Discriminant as shown in,

w=S_{w}⁻¹(m₁−m₂) (2a)

where w is the N-dimensional projection matrix, S_{w} is the within class scatter matrix and m₁, m₂ are the means of the positive and negative classes respectively.

At this point we must deal with a ‘special problem’ which arises from the histogram image. A combination of the gradient magnitude thresholding (see above) and the low level of edges found in typical negative data (due to sky, road, walls etc.) means that a common bin count value in the histogram image is zero for each selected dimension. That is, all N bins counted no gradients over the given threshold. Over a typical video sequence up to 40% of the histogram image ‘pixels’ may contain straight zeros across all 8 dimensions. This may seem an indication that the histogram image discards too much information. However, gradients are still captured around objects such as signs and pedestrians, and therefore only information in regions such as sky or road are discarded. The issue for Fishers Linear Discriminant is that it is only optimal for a Gaussian distribution. The actual distribution at hand is 8-dimensional, concentrated at the origin and strictly positive. Thus, we apply Fishers Linear Discriminant only to those points which are not at the origin to make the distribution appear more Gaussian. No projection is needed for these points and we want the projection to ‘focus’ on the remaining data.

Let,

Ĉᵢ⊂Cᵢ such that ∀PⱼεĈᵢ,Pⱼ≠0 (2b)

so that Ĉᵢ is the subset of the class training data. Cᵢ without the points at the origin. Let the within class scatter matrix Ŝ_{w} be defined using the positive and negative class subsets,

$${\hat{S}}_{w} = {\sum }_{n ∈ {\hat{C}}_{1}} ( {\overline{P}}_{n} - {\hat{m}}_{1} ) {( {\overline{P}}_{n} - {\hat{m}}_{1} )}^{T} + {\sum }_{n ∈ {\hat{C}}_{2}} ( {\overline{P}}_{n} - {\hat{m}}_{2} ) {( {\overline{P}}_{n} - {\hat{m}}_{2} )}^{T} \qquad ( 3 )$$

This gives the final projection matrix,

ŵ=Ŝ_{w}⁻¹(\hat{m}₁−\hat{m}₂). (4)

Once the projection is applied, this weak classifier response can be dealt with in a manner similar to other scalar feature responses, such as Haar-features. Final weak classifier evaluation is applied as in Equation 5.

A popular model for scalar feature responses is the simple lookup table a posteriori maps based on histogram statistics. However, there is a benefit of improved modelling while keeping the fast look-up table. For Haar features this modelling approach yielded a 75% average error reduction [19]. Therefore we apply a similar Smoothed Response Binning Method to our scalar responses of this weak classifier.

The final weak classifier response is defined as,

f(x)=g(ŵ·x) (5)

where x contains the N selected orientations from the histogram image and g( ) is the RealBoost weak learner classification response using the Smoothed Response Binning approach found in [19].

This weak classifier does not always require 8 multiplications in Equation 5, fewer multiplications results in faster feature evaluation. In order to optimize our feature selection, we apply a simple extension to RealBoost-as-defined in Dollar et al. [13]. When optimizing for speed it is natural that if two features give the same error reduction that we should favor the faster one. Dollar et al. introduce the concept of a partial feature fₜ′ which is defined for every feature fₜ with an error bound Zₜ and complexity cₜ. The partial feature is then defined as having an error bound of Zₜ′=Zₜ^{1/c}^{ₜ} and complexity cₜ′=1. They observe that selecting ct copies of fₜ′ reduces the upper bound by Πₜ₌₁^{c}^{ₜ}Zₜ′=Zₜ i.e. selecting cₜ copies of fₜ′ is the same as selecting one copy of fₜ, both in terms of computational cost and the effect on the upper bound.

In this example the strong classifier is composed of a number of weak classifiers described above. Determining a total confidence for the strong classifier in this example involves summing up each individual confidence value response from the weak features which combined makes up the strong classifier, and thresholding this sum. If the sum is above the threshold, the tested image (including a part of the image) is considered “positive”. If the total sum of confidences is below the threshold the image (including part of the image) is considered “negative”. So, the scalar value for each feature indexes a confidence value, and these are summed up and thresholded.

The weak classifier may be lined up after each other, creating a “cascade” that refines the classification to become improved. This approach is often used when the number of negative samples is many orders of magnitude bigger than the number of positive samples.

It will be appreciated by persons skilled in the art that numerous variations and/or modifications may be made to the invention as shown in the specific embodiments without departing from the scope of the invention as broadly described.

For example, although the disclosure here uses features in the context of a cascade of boosted weak classifiers, it may be used in other machine learning frameworks as well.

In this example, to identify an object a classifier may consist of 1 to a very large number of weak classifier. The classifiers may be all of the first embodiment type or the second embodiment type. Alternatively it may be a combination of the two embodiment types.

The histogram image can be changed to encode more complex data in an efficient way, say for example, orientation information not only from a single scale of the input image but from several scales.

The present embodiments are, therefore, to be considered in all respects as illustrative and not restrictive.

### REFERENCES

[1] R. E. Schapire and Y. Singer, “Improved boosting using confidence-rated predictions,” Machine Learning, vol. 37, no. 3, pp. 297-336, 1999. [Online]. Available: citeseer.ist.psu.edu/schapire99improved.html

1. A method of pre-processing an image for use in detecting objects represented in the image, the method comprising the steps of:
(a) determining an orientation value of each point in the image;
(b) for a subset of points in the image determining a distribution of orientation values of points within the subset;
(c) repeating step (b) for different subsets of points; and
(c) storing each of the distributions of orientation values in memory, each distribution of orientation values stored as one word. in memory.

2. The method according to claim 1, wherein the word is comprised of 16, 32, or 64 bits.

3. The method according to claim 1, wherein the orientation value of each point is one of eight values.

4. The method according to claim 1, wherein the subset is comprised of 16 points.

5. The method according to claim 1, wherein in a distribution of orientation values, a total count of an orientation value is stored as 4 bits in memory.

6. The method according to claim 5, wherein the method further comprises determining whether a total count for an orientation value in a distribution of orientation values is more than 15, and if so performing overflow prevention.

7. The method according to claim 1, wherein step (a) further comprises determining an approximate magnitude for each point.

8. The method according to claim 7, wherein the magnitude of a point is the absolute sum of vertical and horizontal gradients for that point.

9. The method according to claim 7, wherein step (b) further comprises only adding the orientation value of a point of a subset to the distribution of that subset if the magnitude is greater than a threshold.

10. The method according to claim 1, wherein each distribution has a root point and the distributions of each subset are stored in sequence according to the sequence that the root points are in the image.

11. Software, being computer readable instructions recorded on computer readable media, that when performed causes the method according to claim 1.

12. Memory of a computer system to store the distributions of orientations values determined using the method of claim 1.

13. A computer system having input means to receive an image, memory to store determined distributions of orientation values and a processor to perform the method of claim 1.

14. A method of training a weak classifier to be used in detecting an object represented in an image, the method comprising the steps of:
(a) for each image of an image training set, determining or receiving a preprocessed version of the image comprised of multiple distributions of orientation values, where each count of an orientation value in a distribution of orientation values is associated with a point from a subset of points in the image;
(b) using the pre-processed versions of the images, determining a confidence map that can provide a .confidence level that a subset of points associated with a distribution of orientation values is at least part of a representation of the object in the image, the index to the confidence map being a total count of two or more orientation values of a distribution of orientation values; and
(c) forming a weak classifier that includes the confidence map.

15. The method of claim 14, wherein step (a) comprises determining the preprocessed version of the image according to the method of claim 1.

16. The method according to claim 14, wherein the object is a road sign or . pedestrian.

17. Software, being computer readable instructions recorded on computer readable media, that when performed causes the method according to claim 14.

18. Memory of a computer system to store a weak classifier that includes a confidence map formed using the method claim 14.

19. A computer system having input means to receive an image, memory to store pre-processed versions of the images and a weak classifier that includes a confidence map, and a processor to perform the method of claim 14.

20. A method of detecting an abject represented in an image using a classifier comprised of multiple weak classifiers, the method comprising the steps of:
(a) determining or receiving a pre-processed version of the image comprised of multiple distributions of orientation values where each count of an orientation value in a distribution of orientation values is associated with a point from a subset of points in the image;
(b) for each weak classifier,
(i) based on the weak classifier, identifying a total count of two or more orientation values in one of the distributions of orientation values;
(ii) based on the weak classifier and the identified total count of two or more orientation values, determining a confidence level; and
(c) combining each confidence level to determine a combined confidence level for the image as having the object represented in the image.

21. The method according to claim 20, wherein step (a) comprises determining the pre-processed version of the image according to the method of any one of claims 1 to 10.

22. The method-according to claim 20, wherein each weak classifier identifies the counts of which two or more orientation values are to be identified in step (b)(i).

23. The method according to claim 20, wherein each weak classifier has an associated, confidence map having the total counts of two or more orientation values as the axes, and step (b)(ii) comprising determining the confidence value in the confidence map that corresponds to the identified total counts of the two or more orientation values in the one distribution of orientation values.

24. The method according to any claim 20, wherein the weak, classifier is trained according to the method of claim 14.

25. The method according to claim 20, wherein the object is a road sign or pedestrian.

26. Software, being computer readable instructions recorded on computer readable media, that when performed causes the method according to claim 20 to be performed.

27. A computer system having memory to store the pre-processed versions of the image, and a processor to perform the method of any claim 20.

28. A method of training a weak classifier to be used in detecting an object represented in an image, the method comprising the steps of:
(a) for each image of a first and a second image set, wherein images of the first image set include a representation of the object and images of the second image set do not include a representation of the object, determining or receiving a pre-processed version of the image comprised of multiple distributions of orientation values where each count of an orientation value in a distribution of orientation values is associated with a point from a subset of points in the image;
(b) determining a projection that discriminates between the pre-processed versions of the first image set and the pre-processed versions of the second image set; and
(c) forming a weak classifier that includes this projection.

29. The method of claim 28, wherein the method further comprises determining a confidence map that uses as an index the result of the projection to provide a confidence value.

30. The method according to claim 28, wherein step (b) utilizes Fisher's Discriminant Analysis.

31. The method according to claim 28, wherein the object is a road sign or pedestrian.

32. Software, being computer readable instructions recorded on computer readable media, that when performed causes the method according to claim 28.

33. Memory of a computer system to store a weak classifier that includes a projection formed using the method of claim 28.

34. A computer-system having memory to store pre-processed versions of images and a weak classifier that includes a projection, and a processor to perform the method of claim 28.

35. A method of detecting an object represented in an image using a classifier comprised of multiple weak classifiers, the method comprising the steps of
(a) determining or receiving a pre-processed version of the image comprised of multiple distributions of orientation values where each count of an orientation value in a distribution is associated with a point from a subset of points in the image;
(b) for each weak classifier
(i) projecting total counts of one or more orientation values of a distribution of orientation values to a scalar value using a projection of the weak classifier, and
(ii) determining a confidence level based on the scalar value and the weak classifier; and
(c) combining each confidence level to determine a combined confidence level for the image as having the object represented in the image.

36. A method according to claim 35, wherein the weak classifier of step (b) is trained according to the method of claim 28.

37. The method according to claim 35, wherein step (b)(ii) comprises using a one-dimensional confidence map of the weak classifier that has as an index the scalar value.

38. The method according to claim 35, wherein in step (b)(i) the one or more orientation values is determined by the weak classifier.

39. The method according to claim 35, wherein the object is a road sign or pedestrian.

40. Software, being computer readable instructions recorded on computer readable media, that when performed causes the method according to claim 35 to be performed.

41. A computer system having memory to store the pre-processed versions of the image, and a processor to perform the method of claim 35.
